(19) United States
(12) Patent Application Publication
(10) Pub. No.: US 2013/0099491 A1
(43) Pub. Date: Apr. 25, 2013

(54) Method and System for Use of Waste Water in Enhanced Geothermal System Power Production and in Minimizing Waste Water Disposal Impacts

(71) Applicant: AltaRock Energy, Inc., Seattle, WA (US)

(72) Inventors: Joe Iovenitti, Walnut Creek, CA (US); Susan Petty, Shoreline, WA (US); William Glassley, Santa Fe, NM (US)

(73) Assignee: AltaRock Energy, Inc., Seattle, WA (US)

(21) Appl. No.: 13/657,757

(22) Filed: Oct. 22, 2012

Related U.S. Application Data
(60) Provisional application No. 61/549,655, filed on Oct. 20, 2011.

(51) Int. Cl. F02C 6/18; F24J 3/08

(52) U.S. Cl. 290/2; 165/45

(57) ABSTRACT

Methods for stimulating at least one fracture within a subterranean formation by pressurizing an injection subterranean well drilled in the subterranean formation with injected waste water are herein disclosed.

The present application claims the benefit of and priority to U.S. Provisional Patent Application No. 61/549,655 entitled “METHOD AND SYSTEM FOR USE OF WASTE WATER IN ENHANCED GEOTHERMAL SYSTEM POWER PRODUCTION AND IN MINIMIZING WASTE WATER DISPOSAL IMPACTS” filed on Oct. 20, 2011, and is hereby incorporated by reference.

### FIELD OF TECHNOLOGY

The present application is directed to the use of waste water for maximizing energy recovery from a subterranean formation and minimizing environmental impact of waste water clean-up and disposal, as well as discharges to surface and ground water.

### BACKGROUND

Waste water treatment is the process of removing contaminants from waste water from any source (e.g. waste water treatment systems, cooling towers and storm water collection systems, mining processes, industrial processes, etc.) by various physical, chemical and biological processes. The objective of waste water treatment is to produce an environmentally-safe treated effluent suitable for disposal, use in non-drinking water applications, and increasing use in drinking water applications. Current common water disposal solutions for municipal waste generally require treatment of waste water by primary and secondary treatment methods, followed by the disposal of treated effluent into surface water (e.g. rivers, streams, lakes and the ocean). In the primary treatment stage, waste water commonly treated with flocculants and other chemical compounds, flows through large sedimentation tanks where solid waste or sludge settles while grease and oils rise to the surface and are skimmed off. In the secondary treatment stage, the biological content of the waste water which is derived from human waste, food waste, soaps and detergent is substantially degraded using aerobic biological processes. In many areas, these types of treatment are of sufficient, thereby causing significant environmental impact and are prohibited under the Clean Water Act. In order to overcome these environmental impacts, tertiary and quaternary treatment methods which raise the effluent quality before it is disposed of into surface and ground water are required. However, these methods are prohibitive in cost, and many municipalities often elect to pay large fines for continuing to dispose of treated effluent to surface waters instead. Nevertheless, many chemical compounds, such as recalcitrant compounds, persist in the water despite these tertiary and quaternary treatments. Another prior disposal solution is to inject the waste water in deep aquifers, a process strictly regulated by environmental agencies such as the U.S. Environmental Protection Agency. However this process is generally energy intensive, expensive, and requires environmental monitoring. Simile issues arise with waste water from other processes and treatment approaches (e.g., mine drainage, oil and gas production, industrial processes, etc.).

Hence, there is a need to minimize the potentially adverse environmental effects of waste water disposal to surface and ground water bodies, as well as a need to minimize waste water treatment costs for non-drinking water applications.

### SUMMARY

Methods for stipulating at least one fracture within a subterranean formation by pressurizing an injection subterranean well drilled subterranean formation with injected waste water are herein disclosed.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying drawings, which are included as part of the present specification, illustrate the presently preferred embodiment of the present invention, and together with the general description given above and the detailed description of the preferred embodiment given below, serve to explain and teach the principles of the present invention.

FIG. 1 is a drawing of an exemplary method for using waste water as the injectate to mine heat from an Enhanced Geothermal System (EGS) reservoir, according to one embodiment.

FIG. 2 is a flow chart that illustrates an exemplary method for using waste water (from any source) as the injectate to mine heat from a stimulated fracture or fractures, referred to as an EGS reservoir, according to one embodiment.

FIG. 3 is a table that lists examples of metal complexes and organic compounds that are often present in treated wastewater and their corresponding upper temperature stability limits.

FIG. 4 is a graph showing the half-life of other example organic contaminants as a function of temperature.

FIG. 5 is a graph that illustrates a flow chart of an exemplary method of how waste water contaminants are reduced or eliminated by thermally-induced chemical effects in the EGS reservoir, according to one embodiment.

FIG. 6 exemplifies a wellfield plan for water use during EGS reservoir creation for shallow depths at lower resource temperatures, according to one embodiment.

FIG. 7 exemplifies a wellfield plan for water use during EGS reservoir creation for deep depths at higher resource temperatures, according to one embodiment.

It should be noted that the figures are not necessarily drawn to scale and that elements of structures or functions are generally represented by reference numerals for illustrative purposes throughout the figures, it also should be noted that the figures are only intended to facilitate the description of the various embodiments described herein. The figures do not describe every aspect of the teachings described herein and do not limit the scope of the claims.

### DETAILED DESCRIPTION

In the following description, for purposes of clarity and conciseness of the description, not all of the numerous components shown in the schematic are described. The numerous components are shown in the drawings to provide a person of ordinary skill in the art a thorough enabling disclosure of the present invention. The operation of many of the components be understood to one skilled in the art.

Each of the additional features and teachings disclosed herein can be utilized separately or in conjunction with other features and teachings to provide a method and system for use of waste water in an EGS system that will minimize the impact of waste water disposal. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated in order to provide additional useful embodiments of the present teachings. In addition it is expressly noted that all features disclosed in the description and/or the claims are intended to be disclosed separately and independently from each other for the purpose of original disclosure, as well as for the purpose of restricting the subject matter independent of the compositions of the features in the embodiments and/or the claims, it is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples.

EGS is a type of geothermal power technology utilizing the high geostatic temperatures of rock strata in which fluid flow has been enhanced by various engineering techniques. The creation of an EGS reservoir involves enhancing fluid permeability by stimulating existing fractures so that their intrinsic permeability is increased. Fractures within subterranean formations are typically enhanced in an un-cased (i.e., open-hole) or liner containing environment by pumping water from the surface down into a subterranean well drilled in a subterranean formation. However, this process used in EGS stimulation is significantly different from those processes used in oil and gas (O&G) hydraulic fracturing.

First, O&G hydraulic fracturing typically involves applying enough pressure and stress on the formation rock to cause tensile failure and the creation of new fractures. In EGS hydroshearing stimulation, pump pressure is maintained at the shear failure pressure and is carefully controlled and limited to prevent tensile failure. EGS hydroshearing stimulation results in the ‘opening’ of existing fractures and prevents the creation of new fractures. Once the fracture is opened, the rock faces can then slip past each other. When the fractures close slightly after stimulation pressure is relieved, the irregularities and asperities between the shifted rock faces do not allow the fractures to close completely, leaving a path for water flow with increased permeability. Another major difference between the two processes is that proppants (e.g., sand) and chemicals are purposefully pumped into the open fractures in O&G hydraulic fracturing operations to hold the fractures open and to aid in the stimulation treatment. For EGS stimulation, however, sand or other proppants are not injected into the formation, nor are chemicals added to the water that is being used to stimulate the formations.

As will be explained in further detail, this present method differs from previous methods used in geothermal power systems, where waste water effluent was being used to replenish depleted geothermal reservoirs solely for pressure maintenance. In the present method, the waste water is not only being used as the working fluid for subsurface and surface heat exchange in the EGS electricity production at the surface, it is also being used in the hydroshearing process as the in estate and in the generation of the EGS reservoir. An important advantage of this process is that organic contaminants are broken down by the heat in the EGS reservoir and inorganic contaminants are sequestered, thus rendering the injected waste water less toxic.

The present disclosure centers on a method and system for the use of waste water from any source (e.g., municipal waste water treatment systems, cooling towers and storm water collection systems; waste water associated with oil and gas production and fracturing operations; coal and oil fired power plants; waste water associated with the dewatering of mines, coal bed methane production, abandoned mines, and other industrial processes, etc.) as the injectate to mine the natural heat in the earth through a man-made geothermal reservoir and/or fracture system in an EGS system. The present method and system is able to use waste water effluent at any treatment stage available so long, as suspended solids (i.e., particulates) that could reduce fluid permeability are sufficiently removed. The use of waste water derived from any source has the benefits of: 1) minimizing waste water treatment costs; 2) minimizing the potential environmental effects and costs of waste water disposal to surface and/or subsurface water bodies; 3) reducing the need for use of uncontaminated surface and ground waters in the EGS process; 4) breaking down or sequestering certain contaminants as a result of circulating the waste water through the high temperature, man-made EGS reservoir; and 5) reducing the amount of treated sludge and other waste products that must be disposed of.

According to one embodiment, the present method uses waste water derived from local municipalities and industries as the injectate to mine the heat from an EGS reservoir. This newly EGS heated fluid would then be produced to the surface significantly cleaner than the original injectate and used as the working fluid in an EGS power production system. The high temperature of the EGS reservoir (generally around 250° Celsius) enhances the chemical breakdown of most organic contaminants present in the waste water. Thus, it is beneficial to use waste water as the injectate for EGS resources in arid or other clean water-sensitive environments.

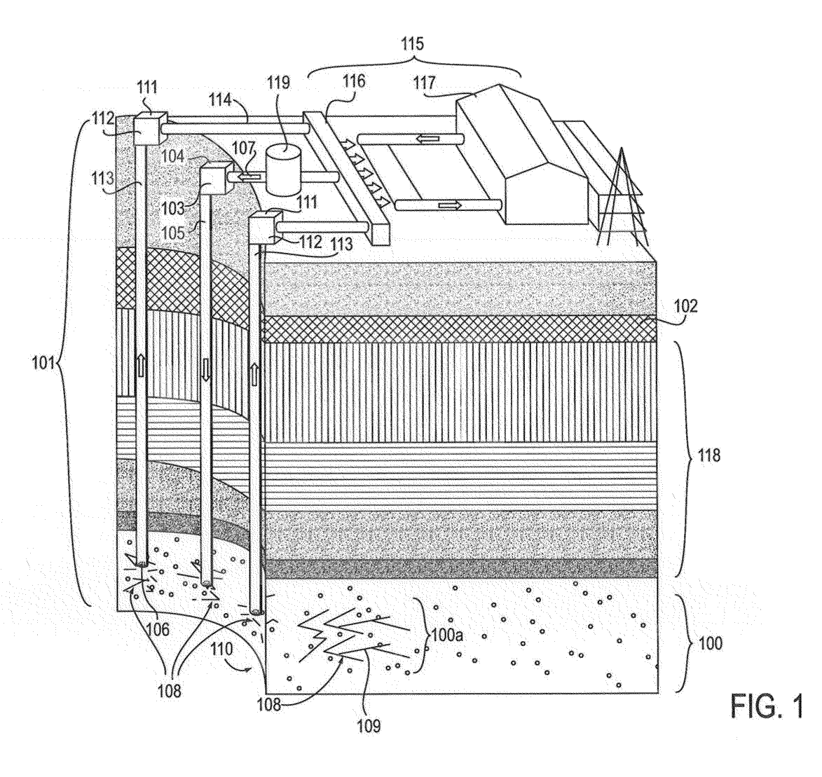

FIG. 1 is a drawing of an exemplary method for using waste water as the injectate to mine heat from an Enhanced Geothermal System (EGS) reservoir, according to one embodiment. At the EGS reservoir 100a, an injection well 103 including an injection wellbore 104 is drilled in subterranean formations 101 and completed in formation 100 within which EGS reservoir 100a is located. Note that depending on the geologic setting, an EGS reservoir 101a could cross rock strata (i.e. formation) boundaries. The injection well 103 includes an injection cased section 105 and an injection open-hole section 106 extending below the cased section 105. The injection cased section 105 of the injection well 103 is lined with long overlapping casing strings. Ground water bearing rock strata 102 generally occurs in the rock strata overlying the created EGS reservoir 100a and these rock strata 102 are cased off in the completed injection well 105.

Waste water used as treatment fluid is injected via pump 119 into the injection wellbore 104 to pressurize the section of the hole to be fractured 106 of the injection well 103. The escape of contaminated waste water into overlying surrounding groundwater in rock strata 102 is prevented due to the long overlapping casing strings in the injection cased section 105, the deep depth of the injection well 103 in the subterranean formation 100, at the impervious overlying geological formations 118. Pressure created by the injected waste water stimulates a fracture or a fracture network 108 in the subterranean formation 100 and creates an EGS reservoir 100a. The injected, waste water may stimulate one or more fracture networks within the subterranean formation 100 to create an EGS reservoir 100a. Methods for creating multiple fracture networks include isolating intervals with higher fracture initiation pressures by blocking existing fractures with temporary fracture sealant, deploying an inflatable or expanding open-hole packer, deploying a scab liner or any method known in the art that is capable of creating multiple fracture networks in the subterranean formation 100.

In one embodiment, waste water enters the fracture during stimulation, applying force in the direction normal to the fracture face (not shown), if the stimulation pressure is great enough to overcome the friction on the fracture face 110, hydroshearing (or shearing) will occur. As sneering occurs, the faces of the fracture will move from their original position and increase in aperture. Once the fractures are opened, the rock faces can then slip past each other. When the fractures close slightly after stimulation pressure is relieved, the irregularities and asperities between the shifted rock faces do not allow the fractures to close completely. This leaves a path for water flow with increased permeability. After a fracture network 108 it the subterranean formation 100 has been created, the injected waste water is circulated through the fracture network 108 where it is heated. In other embodiments, instead of using hydroshearing, other methods and techniques (e.g. tension fracturing, etc.) that allow use of wastewater for heat mining will occur to a person of ordinary skill in the art.

According to one embodiment, waste water is circulated through the cracks 109 in the fracture network 108 and heats up to geostatic temperature of the subterranean formation 100. At some distance away from the injection well 103, a production well 111 including a production wellbore 112 is drilled in the subterranean formation 100. The production well 111 produces 114 the heated waste water to the surface and the heated waste water is used as the working fluid in an EGS power production system 115. One or more production wells used to produce 114 the heated waste water to the surface, according to one embodiment. The production well 111 includes a production cased section 113 which similarly prevents the escape of contaminated waste water into surrounding groundwater 102 during the production 114 of heated waste water. According to one embodiment, the production well 111 produces 114 the heated waste water to the surface where the steam is separated from the heated waste water and used to drive steam turbines in the EGS power production system 115. According to another embodiment, the production well 111 produces 114 the heated ater to the surface and the heated waste water is supplied into heat exchangers 116 to boil other fluids which will vaporize and drive other turbines in the power plant 117 in the EGS power production system 115. After the heated waste water has been used as the working fluid in an EGS power production system 116, the waste water is then pumped 107 back into the injection well 103 and the process is repeated.

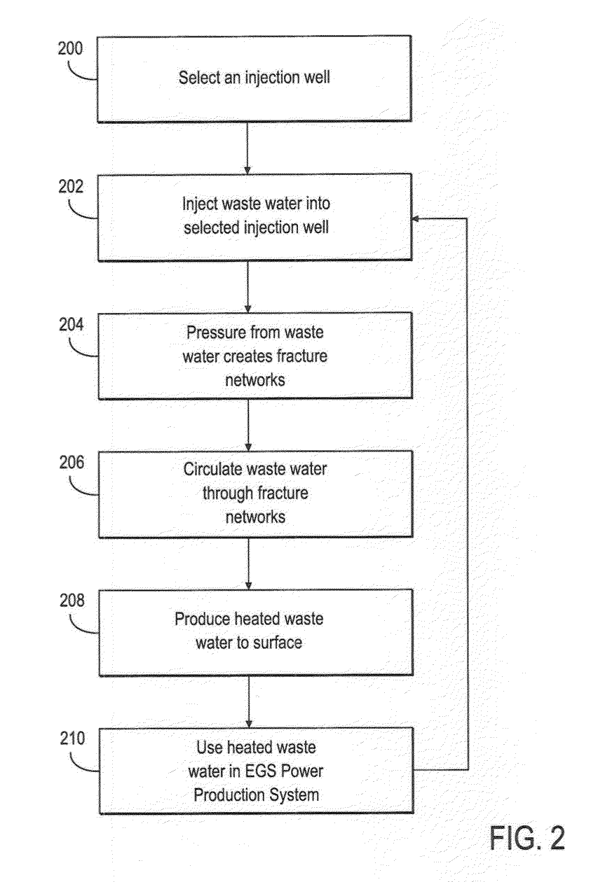

FIG. 2 is a flow chart that illustrates an exemplary method for using waste water (from any source) as the injectate to mine heat from a stimulated fracture or fractures, referred to as an EGS reservoir, according to one embodiment. Several injection wells (including their respective injection wellbores) drilled in a subterranean formation, and this process can be repeated for multiple injection, wells in the disclosed system. At 200, an injection well is selected to begin operations. At 202, waste water as treatment fluid is injected into the injection well to stimulate and pressurize a portion of the subterranean formation. At 204, pressure builds from the injected waste water, creating one or more fracture networks in the subterranean formation. At 206, the waste water is circulated through the fracture networks where it is heated to geostatic temperature of the subterranean formation. At 208, the heated waste water is, produced to the surface by one or more production sells some appropriate distance away from the injection well, according to one embodiment. Heated waste water may also be produced to the surface from the same injection well, according to another embodiment. At 210, the heated waste water that produced to the surface is used as working fluid to generate electricity in EGS power production system. After the heated waste water has been used in the EGS power production system, the waste water is injected again into the injection well as shown in 202 and the process is repeated so that the waste water is always contained within the closed loop system of the EGS reservoir. Therefore, contaminants in the waste water are circulated through the closed loop system and if possible broken down by heat, which is explained further in the following sections.

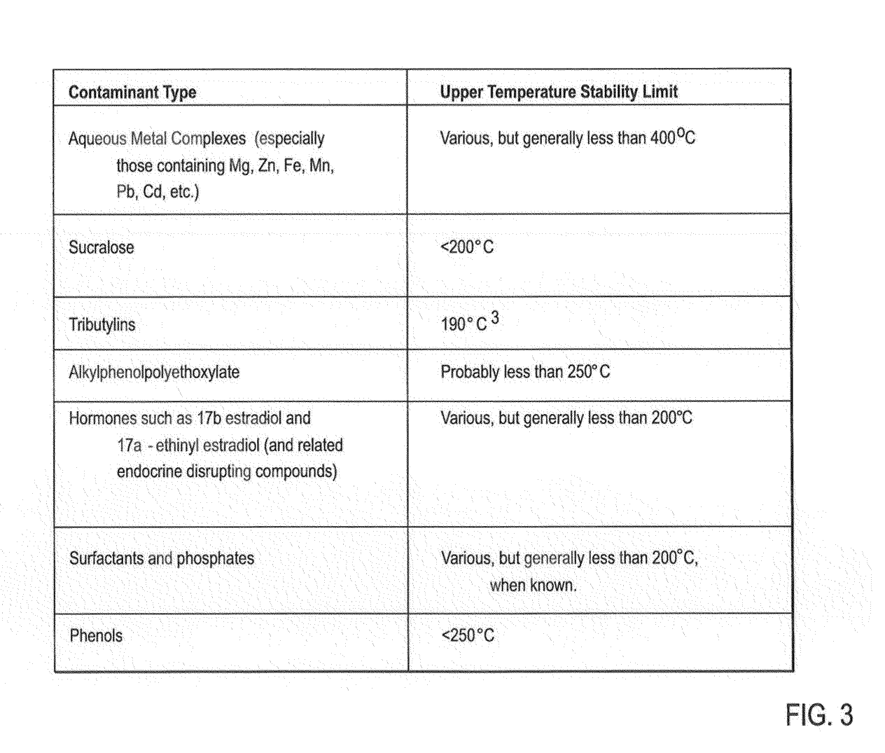

Wastewater is a complex chemical solution consisting of compounds from industrial, commercial, and domestic sources. Depending upon the source, the wastewater will contain various proportions of soluble metal complexes, organic compounds (e.g., polymers, hormones, dyes, surfactants, phenols, synthetic compounds organo-phosphates, etc.), and inorganic compounds including but not limited to radioactive constituents. Although treatment in waste ater treatment facilities using a valets of technologies is often employed (e.g., ultraviolet radiation oxygenation, flocculation/precipitation, elevated temperature, etc.) it is seldom sufficient to eliminate all potential pollutants. For example, treatment in waste treatment facilities is seldom at temperatures above that of steam (˜100° C.), which is insufficient to breakdown most metal complexes to a simpler, less active state. FIG. 3 is a table that list examples of metal complexes and organic compounds that are often present in treated wastewater and their corresponding upper temperature stability limits.

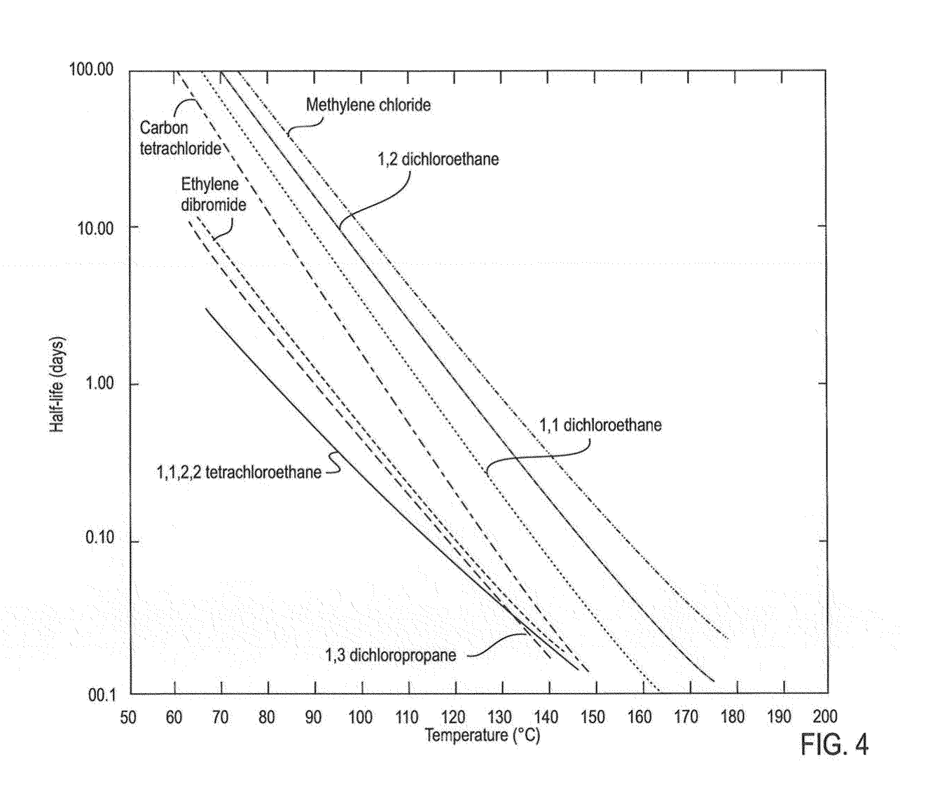

However, treatment of many of these compounds at the elevated temperatures encountered in Enhanced Geothermal Systems (EGS) is sufficient to result in their chemical degradation. For example, aqueous metal complexes (AMCs) undergo a wide range of dissociation and precipitation reactions to form hydroxides, carbonates, sulfates and other compounds at elevated temperatures, depending on the acidity and chemical composition of the solvent water and rock the fluid containing the AMC's is flowing through. As another example, trialkyl-, alkyl aryl and triaryl phosphates, and most organic compounds dissolve in water via hydrolysis reactions of the form RX+H₂O [symbol] ROH+XH, where R functional group on an organic (or other) molecule (X) and are converted to unsaturated hydrocarbons (ROH) and phosphorus acids or other XH molecules. The chemical degradation of compounds varies with the conditions they are subjected to. FIG. 4 is a graph showing the half-life of other example organic contaminants as a function of temperature.

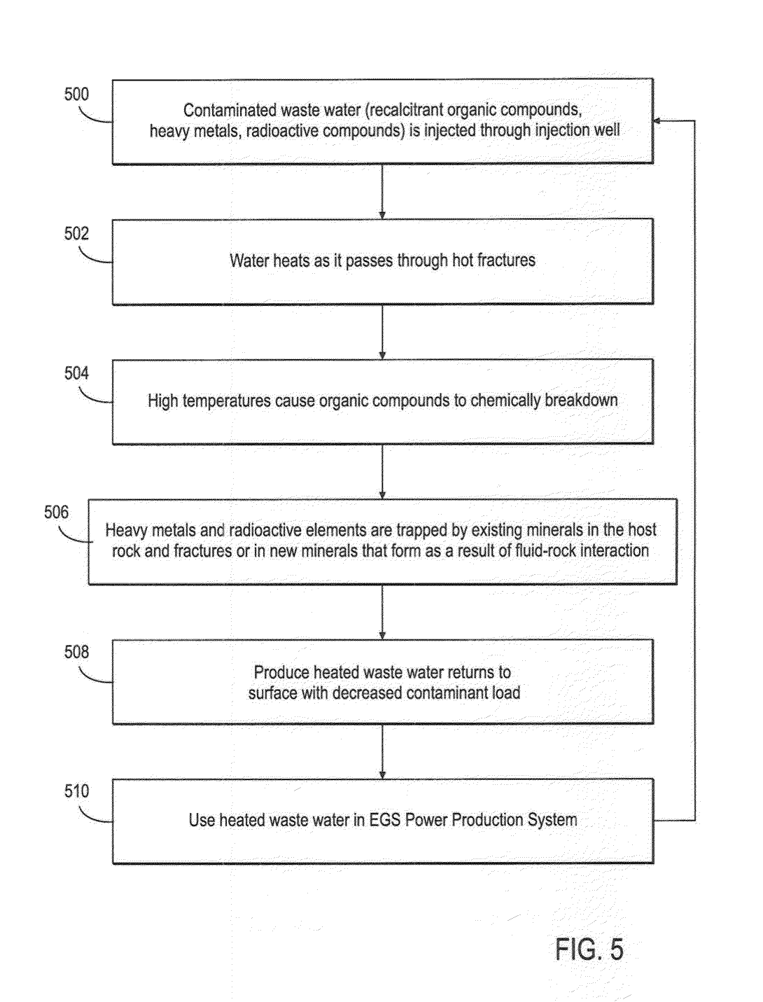

FIG. 5 is a graph that illustrates a flow chart of an exemplary method of how waste water contaminants are reduced or eliminated by thermally-induced chemical effects in the EGS reservoir, according to one embodiment. At 500, contaminated waste water is injected into the geothermal reservoir. At 602, the water is heated as it flows in contact with the fracture system, and organic compounds (e.g., 17β-estradiol, bisphenylA, etc., that are commonly present in, municipal wastes) will begin to chemically breakdown at 504 as they reach their thermal stability limits. In addition, inorganic contaminants such as heavy metals aid radioactive dissolved elements can begin to interact at 506 with minerals already present in the rock or new minerals that form and become sequestered there, further lowering the contaminants in the waste water. At 608, the waste water returns to the surface with a reduced load of contaminants, passes trough the power generation system and is then re-injected into the EGS reservoir at 510.

According to one embodiment, EGS projects experience some amount of water loss during the injection and production processes. Accordingly, water is required to be used as “make up water” in the production process. Generally, around 1-5% of the total flow will be lost to the surrounding rock, for each cycle. This amounts to about ⅓ kg/s per MW (6 gpm per MW) for a 200° C. resource. For instance, a 100 MW project will require 600 gpm of make up water.

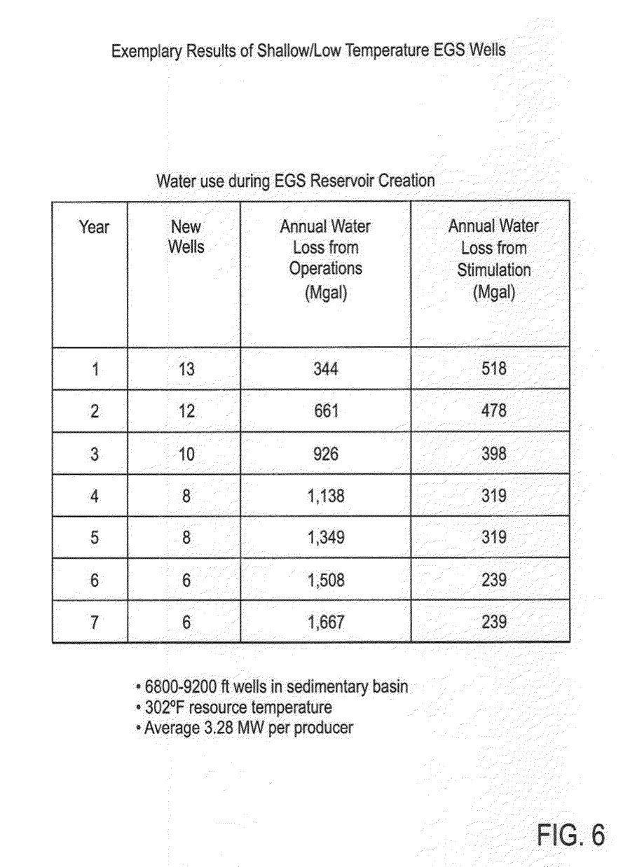

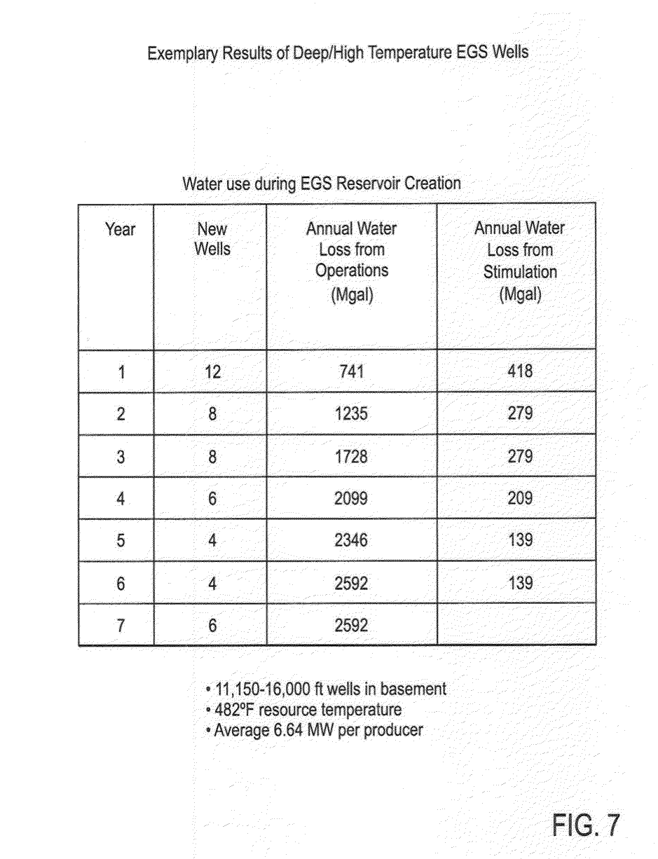

According to one embodiment, water loss could vary with the depth and geostatic temperature of the EGS wells. FIG. 6 exemplifies a wellfield plan for water use during EGS reservoir creation for shallow depths at lower resource temperatures, according to one embodiment. FIG. 6 shows sample data from a shallow-depth/lower-temperature EGS well, documenting the annual water loss resulting from both operations and hydroshearing stimulation procedures. For example, the approximately 2.1-2.8 kilometer (6,800-9,200 ft.) EGS well in FIG. 6 averaged a 150° C. (302° F.) temperature, resulting in a 3.28 MW average per production well. FIG. 7 exemplifies a wellfield plan for water used during EGS reservoir creation for deep depths at higher resource temperatures, according to one embodiment. FIG. 7 shows the same data statistics as FIG. 6 for, an approximately 3.4-4.8 kilometer (11,150-16,000 ft.) EGS well with a 250° C. (482° F.) average temperature, resulting in 6.64 MW average per production well. As can be seen from a comparison of the tables in FIGS. 6 and 7, annual water loss resulting from operations was higher for the deeper-depth EGS well of FIG. 7 than it was for the shallow-depth EGS well of FIG. 6. Differing well depths resulting in different data will occur to those of ordinary skill in the art.

The benefits of the present method and system also apply industrial waste, process water and heated waste water from power plants. Because this water is used in the closed loop system of the EGS project, contaminants not broken down at or fixed in the man-made EGS reservoir conditions will be circulated through the system, and if possible, successively broken down by heat and/or sequestered by heat and water-rock reactions in the aforementioned reservoir. The escape of this contaminated fluid into the overlying groundwater would be prevented by the deep depth, long overlapping casing strings, and impervious rock above the EGS reservoir. In all waste water types, particulates would need to be removed to an appropriate level prior to injection into the man-made EGS reservoir.

Example embodiments have been described hereinabove regarding the use of waste water from any source as the injectate to mine the natural heat in the earth through a man-made geothermal reservoir for EGS power production. Various modifications to and departures from the disclosed example embodiments will occur to those having ordinary skill in the art. The subject matter that is intended to be within the spirit of this disclosure is set forth in the following claims.

We claim:

1. A method comprising:
stimulating at least one fracture within a subterranean formation by pressurizing an injection subterranean well drilled in the subterranean formation with injected waste water.

2. The method as recited in claim 1, further comprising the injected waste water flowing through the at least one fracture and heating to geostatic temperature of the subterranean formation,
wherein heating the injected waste water to geostatic temperatures produces heated waste water, and
wherein heating the injected waste water to geostatic temperatures chemically breaks down organic contaminants and sequesters metal contaminants contained within the injected waste water.

3. The method as recited in claim 2, wherein the heated waste water is circulated from the at least one fracture to a production subterranean well drilled in the subterranean formation.

4. The method as recited in claim 3 wherein the heated waste water circulated to the production subterranean well is supplied to an Enhanced Geothermal System (EGS) power generation system to generate electricity.

5. The method as recited in claim 4, wherein supplying the heated waste water comprises using steam from the heated waste water to drive a steam turbine.

6. The method as recited in claim 4, wherein supplying the heated waste water comprises using the heated waste water to boil a fluid that vaporizes and drives a steam turbine.

7. The method as recited in claim 4, wherein after the heated waste water is supplied to an EGS power generation system, the waste water is then re-injected back into the injection subterranean well to stimulate the at least one fracture within the subterranean formation.

8. A method comprising:
stimulating at least one fracture within a subterranean formation by pressurizing an injection subterranean well drilled in the subterranean formation with injected waste water;
circulating the injected waste water flowing through the at least one fracture to heat the injected waste water to the geostatic temperature of the subterranean formation,
wherein heating the injected waste water to geostatic temperatures produces heated waste water, and
wherein heating the injected waste water to geostatic temperatures chemically breaks down and sequesters contaminants contained within the injected waste water;
circulating the heated waste water from the east one fracture to a production subterranean well drilled in the subterranean formation;
supplying the heated waste water from the production subterranean well to an Enhanced Geothermal System (EGS) power generation system to generate electricity; and
re-injecting the waste water from the EGS power generation system to the injection subterranean well.

9. The method as recited in claim 8, wherein supplying the heated waste water comprises using steam from the heated waste water to drive a steam turbine.

10. The method as recited in claim 8, wherein supplying the heated waste water comprises using the heated waste water to boil a fluid that vaporizes and drives a steam turbine.

11. The method as recited in claim 8, wherein heating the injected waste water to geostatic temperatures chemically breaks down organic contaminants contained within the injected waste water.

12. The method as recited in claim 8, wherein heating the injected waste water to geostatic temperatures sequesters metal contaminants including at least radionuclides contained within the injected waste water.
